(19) United States
(12) Patent Application Publication
(10) Pub. No.: US 2007/0157669 A1
(43) Pub. Date: Jul. 12, 2007

(54) Manufacturing apparatus of glass product and manufacturing method applied to the apparatus

(76) Inventors: Shunichi Hayamizu, Amagasaki-shi (JP); Yoshihiro Kamada, Osaka (JP); Tadafumi Sakata, Kobe-shi (JP)

Correspondence Address: BRINKS HOFER GILSON & LIONE, P.O. BOX 10395, CHICAGO, IL, 60610, US

(21) Appl. No.: 11/651,693

(22) Filed: Jan. 10, 2007

(30) Foreign Application Priority Data
Jan. 11, 2006 (JP) 2006-003618

(51) Int. Cl. C03B 11/00; C03B 7/14; C03B 13/00

(52) U.S. Cl. 65/66; 65/122; 65/223

(57) ABSTRACT

A manufacturing apparatus of a glass product, comprising: a plurality of lower molds; a nozzle for allowing a molten glass droplet to drop therefrom; and a shifting unit for successively shifting any one of lower molds, selected among the lower molds, to a dropping position at which the molten glass droplet drops from the nozzle in synchronized timing with dropping of the molten glass droplet, which can efficiently press-mold molten glass droplets that are allowed to drop from a nozzle of a melting tank; and a manufacturing method applied to the apparatus.

This application is based on application No. 2006-003618 filed in Japan, the contents of which are hereby incorporated by reference.

### BACKGROUND OF THE INVENTION

1. Field of the Invention

The present invention relates to a manufacturing apparatus of a glass product, which molds a molten glass droplet flowing out from a nozzle by using a mold.

2. Description of the Related Art

In an attempt to precisely mold a glass product, such as a glass gob or an optical element like a lens and a prism, as shown in FIG. 1, the use of molten glass 124 which is allowed to naturally drop from a nozzle 120 of a melting tank 110 by gravity as droplets is known.

A method is also known in which a predetermined amount of a molten glass droplet is dropped by cutting a molten glass flowing out continuously from a nozzle by means of a shear cutter.

In the case of the former method, a molten glass is kept at the tip of the nozzle 120 while an amount of glass allowed to flow out from the nozzle 120 is small. When the amount of the molten glass allowed to flow out from the nozzle 120 increases and the mass of the molten glass allowed to flow out exceeds wettability, the molten glass droplet 124 leaves naturally from the nozzle 120 by gravity and is allowed to drop naturally.

Generally, a process has been used in which: a molten glass droplet 124 is allowed to drop onto a lower mold 130 and the lower mold 130 on which the molten glass droplet 124 has been put is moved toward an upper mold 140 so that the molten glass droplet 124 is press-molded inside a mold constituted by the upper mold 140 and the lower mold 130 (for example, see Japanese Patent Application Laid-Open No. 2002-234740).

When the molten glass is allowed to drop from the nozzle 120 as molten glass droplets 124, the molten glass drops down with a comparatively short cycle, such as several seconds, like water droplets dropping down from a faucet of water line (here, the dropping cycle is denoted as T1). In contrast, the press molding cycle of the molten glass droplets 124 (here, the molding cycle is denoted as T2), which requires many processes including a process used for receiving the molten glass droplet 124 on the lower mold 130, a process used for shifting the lower mold 130 toward the upper mold 140, a process used for press-molding the molten glass droplet 124 between the upper and lower molds 130 and 140, a process used for cooling the molded product, a process used for taking out the molded product and a process used for returning the lower mold 130 to the dropping position, forms a comparatively long cycle of, for example, at least 10 seconds. Especially, it is necessary to secure a sufficiently long period for the press molding process so that the shape of molds may be transcribed well on a molded article. Although fine adjustments of the dropping cycle can be made by adjusting the temperature of the nozzle 120 using a heater 112, it is difficult to carry out a big time adjustment because the temperature range of the nozzle 120 suitable for molding.

Therefore, in the case of T1>T2, that is, in the case when the dropping cycle is longer than the molding cycle, all the molten glass droplets can be molded by using a pair of molds 130 and 140. In contrast, in the case of T1<T2, that is, in the case when the dropping cycle is shorter than the molding cycle, upon molding by using a pair of molds 130 and 140, molten glass droplets 124 that are not properly synchronized with the molding timing are wasted. Especially, when comparatively small optical elements, for example, a taking lens for portable apparatus, such as a cellular phone, and an optical element for pickup of recording medium, such as DVD, is molded, it is necessary to make a molten glass droplet small, so that the dropping cycle becomes inevitably short. In this manner, when the dropping cycle is shorter than the molding cycle, the molten glass droplets 124 are discarded without being utilized to cause losses and the resulting problem of low productivity.

### BRIEF SUMMARY OF THE INVENTION

A technical objective to be achieved by the present invention is to provide a manufacturing apparatus of a glass product which can efficiently utilize molten glass droplets that are allowed to drop from a nozzle of a melting tank.

The present invention provides manufacturing apparatus of a glass product, comprising:

a plurality of lower molds;

a nozzle for allowing a molten glass droplet to drop therefrom; and

a shifting unit for successively shifting any one of lower molds, selected among the lower molds, to a dropping position at which the molten glass droplet drops from the nozzle in synchronized timing with dropping of the molten glass droplet, and a manufacturing method of a glass product, comprising:

shifting one of plurality of lower molds to a predetermined dropping position;

dropping a molten glass droplet on the lower mold positioned at the dropping position from a nozzle;

moving the lower mold with the molten glass droplet received thereon from the dropping position; and

shifting another lower mold to the dropping position.

### BRIEF DESCRIPTION OF THE DRAWINGS

FIG. 1 is a schematic drawing that shows a manufacturing apparatus of an optical element relating to the prior art.

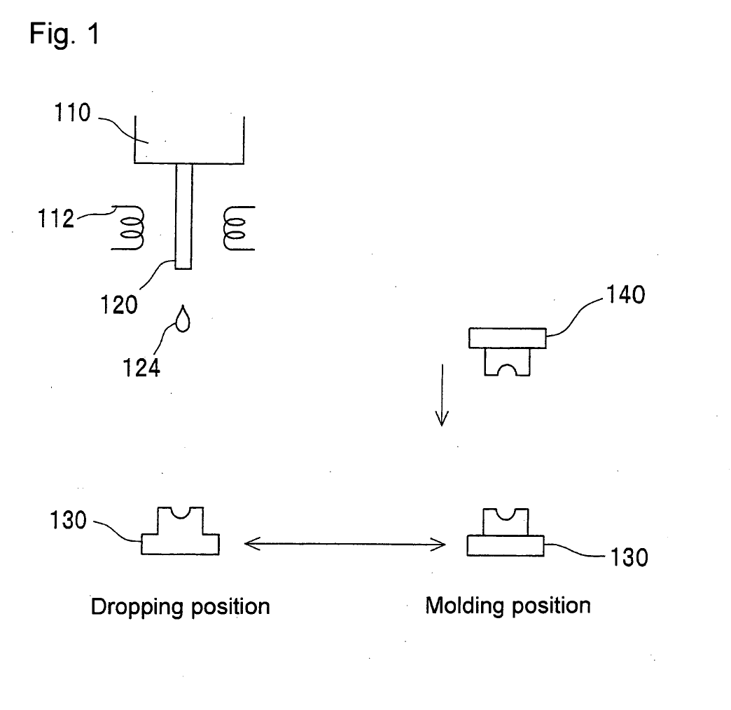

FIG. 2 is a schematic drawing that explains a manufacturing apparatus of an optical element in accordance with one embodiment of the present invention.

FIG. 3 is an explanatory drawing that shows the manufacturing apparatus of an optical element of FIG. 2 viewed from above.

FIG. 4 is an explanatory drawing that shows a manufacturing apparatus of an optical element in accordance with another embodiment of the present invention, viewed from above.

FIG. 5 is an explanatory drawing that shows a manufacturing apparatus of an optical element in accordance with still another embodiment of the present invention, viewed from above.

### DETAILED DESCRIPTION OF THE INVENTION

### [Means to Solve the Problems and Functions and Effects]

In order to achieve the above-mentioned technical objective, the present invention provides the following manufacturing apparatus of a glass product.

In other words, a manufacturing apparatus of a glass product in accordance with the present invention is characterized by including: manufacturing apparatus of a glass product, comprising:

a plurality of lower molds;

a nozzle for allowing a molten glass droplet to drop therefrom; and

a shifting unit for successively shifting any one of lower molds, selected among the lower molds, to a dropping position at which the molten glass droplet drops from the nozzle in synchronized timing with dropping of the molten glass droplet.

Any one of lower molds, selected among a plurality of lower molds, is successively moved to the dropping position in synchronized timing with dropping of the molten glass droplet, and allowed to receive the molten glass droplet. Therefore, it becomes possible to greatly reduce the loss in which molten glass droplets are discarded without being utilized, and consequently to greatly improve productivity of glass products.

By receiving the molten glass droplet by the use of the lower mold, it is possible to manufacture a glass gob having the lower face of a molded face, and the upper face of a free face, and the molding means, which is provided with the lower mold and an upper mold that is paired with the lower mold respectively, allows the lower mold which has received the molten glass droplet to move to another molding position apart from the dropping position so that the glass gob is press-molded by the upper mold to form an optical element.

The press-molding operation, which requires many processes including a process used for receiving the molten glass droplet on the lower mold, a process used for shifting the lower mold toward the upper mold, a process used for press-molding the molten glass droplet between the upper and lower molds, a process used for cooling the molded product, a process used for taking out the molded product and a process used for returning the lower mold to the dropping position, forms a comparatively long cycle. The dropping cycle may be adjusted in accordance with the press-molding operation; however, when the dropping cycle is prolonged in accordance with the press-molding operation, the molten glass droplet forms a coat film on its surface, making the dropping process of the molten glass droplets unstable. Therefore, in order to stably supply the molten glass droplets, the dropping cycle in which the molten glass droplets are allowed to drop is preferably made shorter than the molding cycle in which each molten glass droplet is molded by the upper and lower molds.

### BEST MODE FOR CARRYING OUT THE INVENTION

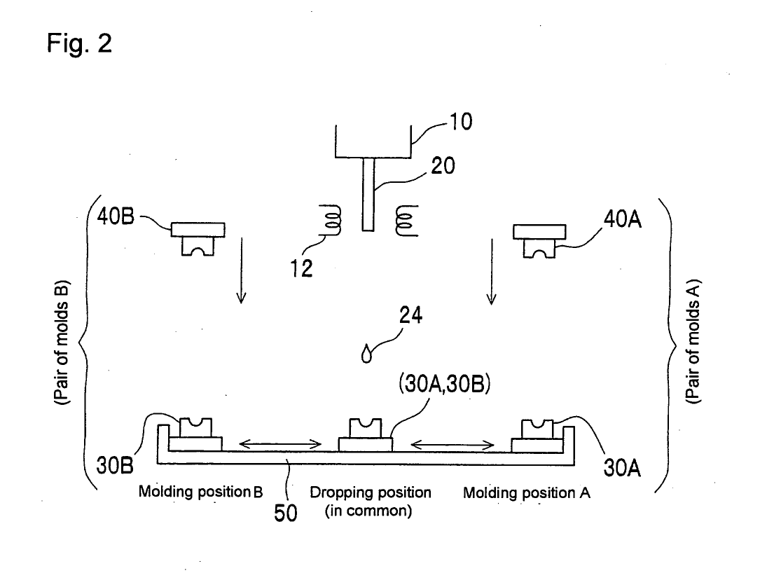

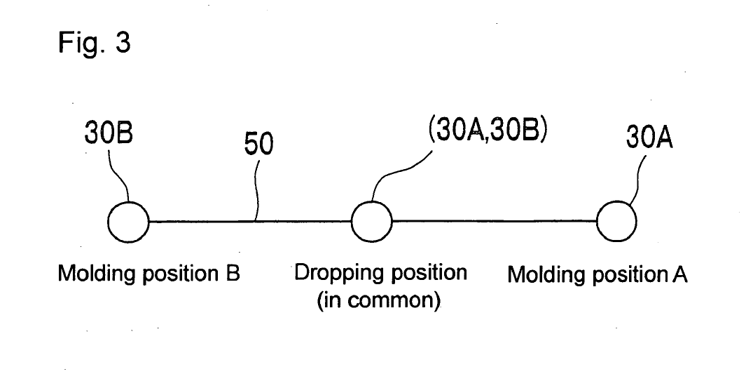

Referring to FIGS. 2 and 3, the following description will discuss an embodiment of a manufacturing apparatus of an optical element in accordance with the present invention in detail.

FIG. 2 is a schematic drawing that explains the manufacturing apparatus of an optical element in accordance with an embodiment of the present invention, and FIG. 3 is an explanatory drawing that shows the manufacturing apparatus of an optical element shown in FIG. 2 viewed from above.

As shown in FIG. 2, the manufacturing apparatus of an optical element in accordance with the present invention is provided with a molten glass supplying unit that supplies a molten glass droplet 24 to a lower mold 30A or 30B, a shifting unit used for successively shifting either one of the two lower molds 30A and 30B to a dropping position of the molten glass droplet 24 in synchronized timing with the dropping of the molten glass droplet 24, and a press-molding unit that press-molds the molten glass droplet 24 alternately by using either a pair of molds 30A and 40A or a pair of molds 30B and 40B.

The molten glass supplying unit is basically constituted by a melting tank 10 used for melting glass, a nozzle 20 attached to the bottom portion of the melting tank 10 so as to direct molten glass to the outside, and lower molds 30A and 30B placed at dropping positions at which the molten glass droplet 24 that drops naturally from the tip of the nozzle 20 is received.

The temperatures of the melting tank 10 and the nozzle 20 are maintained at predetermined temperatures by a heating heater 12. The dropping interval of the molten glass droplets 24 is kept approximately constant. The passage of the molten glass droplet 24 is detected by a dropping detection sensor that is constituted by a pair of a light-emitting unit and a light-receiving unit, and placed in the dropping passage of the molten glass droplet 24, and the detected signal is sent to the control unit so as to be fed back to the heating heater 12 so that the dropping interval can be controlled more accurately. The dropping interval can be desirably set by properly balancing the heating heater. The dropping interval is preferably set in an interval of 1 to 20 seconds so as to carry out a stable dropping operation.

In order to heat the melting tank 10 and the nozzle 20, a heater, a high frequency coil, an infrared lamp or the like may be used. In particular, upon heating them to a high temperature of 1000° C. or more, the high frequency heating process is effectively used.

When molten glass is allowed to flow out from the tip portion of the nozzle 20, the molten glass thus flowed out grows into a molten glass droplet 24 having a predetermined weight at the tip, and the resulting molten glass droplet 24 is allowed to naturally drop by gravity. The molten glass droplet 24, dropped naturally, is received as a glass gob on a concave-shaped lower molding surface of either one of the lower molds 30A and 30B located at the dropping position. The lower molds 30A and 30B are preferably placed 10 to 50 cm below the tip portion of the nozzle 20.

The temperature of the lower molds 30A and 30B may be set to room temperature, and is not particularly required to be controlled. However, since wrinkles tend to occur in the glass gob when the temperature of the lower molds 30A and 30B is too low, it is effective to carry out the temperature control by a heating means and a cooling means. The temperature of the upper molds 40A and 40B is not particularly required to be controlled as well; however, it is effective to carry out the temperature control by a heating means and a cooling means.

With respect to the lower molds 30A, 30B and the upper molds 40A, 40B, heat resistant materials, such as a ceramic material, hard alloy, carbon and metal, may be used, and from the viewpoints of superior thermal conductivity and low reactivity to glass, carbon and a ceramic material are preferably used.

The shifting unit is constituted by a guide 50 that guides linear sliding movements in horizontal right and left directions of the lower molds 30A and 30B, a driving means that drives the lower molds 30A and 30B in horizontal right and left directions and a controlling device that controls the timing of the sliding movements of the lower molds 30A and 30B in horizontal right and left directions. The driving means can be constituted by a driving cylinder driven by air pressure or hydraulic pressure and a linear motor. The molding position A and the molding position B are placed symmetrically with 180 degrees, with the dropping position being located in the center. Either one of the lower molds 30A and 30B, which has received the molten glass droplet 24 at the dropping position is allowed to slide and move along the guide 50 in the horizontal direction toward either one of the molding positions A and B at which the corresponding one of the upper molds 40A and 40B is waiting.

At the molding position A, the upper mold 40A is placed so as to face the lower mold 30A. The upper mold 40A is driven upward or downward vertically by the press molding means. The press molding means may be formed by a drive cylinder that is driven by air pressure or hydraulic pressure. The molten glass droplet 24, placed on the lower molding surface of the lower mold 30A, is pressed and molded between the lower molding surface of the lower mold 30A and the upper molding surface of the upper mold 40A.

At the molding position B, the upper mold 40B is placed so as to face the lower mold 30B. The upper mold 40B is driven upward or downward vertically by the press molding means. The press molding means may be formed by a drive cylinder that is driven by air pressure or hydraulic pressure. The molten glass droplet 24, placed on the lower molding surface of the lower mold 30B, is pressed and molded between the lower molding surface of the lower mold 30B and the upper molding surface of the upper mold 40B.

In the manufacturing apparatus having the above-mentioned structure, the following description will discuss, for example, a process in which the dropping cycle of molten droplets 24 is set to five seconds while the molding cycle of the molten droplets 24 is set to 15 seconds.

First, the lower mold 30A is located at the dropping position in the center, and the lower mold 30B is located at the molding position B. Molten glass droplets 24 are allowed to drop with an interval of 5 seconds, and upon detecting the fact that the first molten glass droplet 24 has dropped onto the lower mold 30A by the dropping detection sensor, a molding cycle is started. Immediately after the start, the lower mold 30A is shifted to the molding position A by the driving means. The press molding means drives the upper mold 40A to move downward so as to press and mold the molten glass droplet 24 in cooperation with the lower mold 30A. The molded product is cooled with the molds being closed, and after a lapse of 12 seconds from the start of the molding cycle, the press molding means allows the upper mold 40A to move upward; thus, the molds are opened so that the molded product is taken out. The driving means drives the lower mold 30A to shift to the dropping position after a lapse of 13 seconds from the start of the molding cycle. After a lapse of 15 seconds from the start of the molding cycle, the fourth molten glass droplet 24 is again received and the above-mentioned operations are repeated.

On the other hand, after a lapse of 7.5 seconds from the start of the molding cycle, the lower mold 30B, located at the molding position B, is shifted to the dropping position by the driving means. Upon detection of the fact that the third molten glass droplet 24 has dropped on the lower mold 30B, the driving means immediately drives the lower mold 30B to move to the molding position B. The press molding means drives the upper mold 40B to move downward so as to press and mold the molten glass droplet 24 in cooperation with the lower mold 30B. The molded product is cooled with the molds being closed, and after a lapse of 19.5 seconds from the start of the molding cycle, the press molding means allows the upper mold 40B to move upward; thus, the molds are opened so that the molded product is taken out. After a lapse of 20 seconds from the start of the molding cycle, the lower mold 30B is shifted to the dropping position by the driving means. After a lapse of 22.5 seconds from the start of the molding cycle, the sixth molten glass droplet 24 is again received and the above-mentioned operations are repeated.

In the above-mentioned example, the press molding operation is carried out by using two pairs of molds 30A and 40A, 30B and 40B, with a molding cycle of 15 seconds in association with a dropping cycle of 5 seconds; therefore, the second and fifth molten glass droplets 24 are not utilized. However, in the case when the same process is carried out by using a pair of molds in the apparatus as explained in the prior art section, the second, third, fifth and sixth molten glass droplets are not utilized. Therefore, by using the apparatus relating to the present invention, it becomes possible to improve the utilization efficiency of the molten glass droplets 24 in comparison with the prior art apparatus.

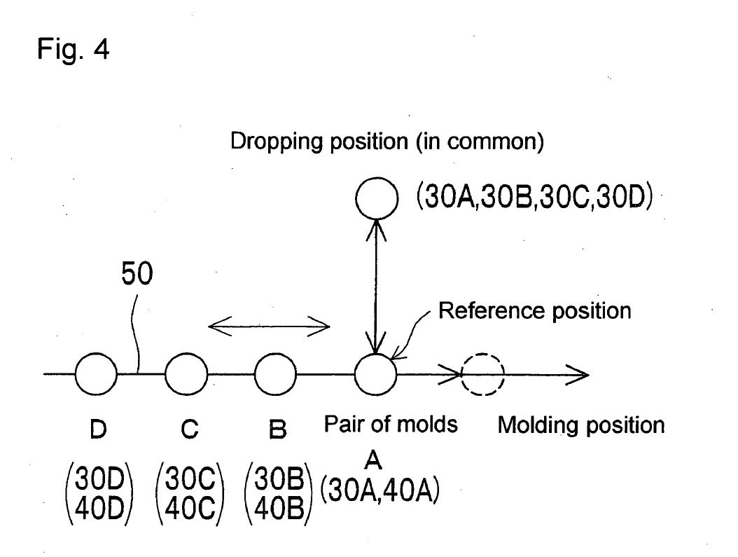

Referring to FIG. 4, the following description will discuss another embodiment of the manufacturing apparatus of an optical element of the present invention in detail; however, by omitting overlapped explanations with the above-mentioned embodiment, different points between the embodiments are mainly explained.

FIG. 4 is an explanatory drawing that shows the manufacturing apparatus of an optical element of another embodiment of the present invention viewed from above.

As shown in FIG. 4, the manufacturing apparatus is provided with: a molten glass supplying unit that supplies a molten glass droplet 24 to any one of four lower molds 30A, 30B, 30C and 30D at the dropping position; a total shifting unit used for successively shifting four pairs of molds, that is, 30A and 40A, 30B and 40B, 30C and 40C, 30D and 40D, as one group; a shifting unit that allows any one of the four lower molds 30A, 30B, 30C and 30D to successively move between a dropping position and a reference position reciprocally in synchronized timing with the dropping of the molten glass droplet 24, and a press-molding unit that press-molds the molten glass droplet 24 by using any one of the four pairs of molds, that is, 30A and 40A, 30B and 40B, 30C and 40C, 30D and 40D.

The total transporting unit is constituted by a transporting path provided with a lower guide 50 that linearly guides sliding movements in horizontal right and left directions of the four lower molds 30A, 30B, 30C and 30D, and an upper guide that linearly guides sliding movements in horizontal right and left directions of the four upper molds 40A, 40B, 40C and 40D, a driving means that reciprocally drives the four pairs of molds 30A and 40A, 30B and 40B, 30C and 40C, 30D and 40D, in horizontal right and left directions as one group, and a controlling device that controls the timing of the reciprocal movements in horizontal right and left directions of the four pairs of molds 30A and 40A, 30B and 40B, 30C and 40C, 30D and 40D.

The transporting unit is constituted by a lower guide that guides sliding movements in horizontal forward and backward directions of the four lower molds 30A, 30B, 30C and 30D, a driving means that successively drives any one of the lower molds among the four lower molds 30A, 30B, 30C and 30D reciprocally in horizontal forward and backward directions between a dropping position and a reference position, and a controlling device that controls the timing of the reciprocal movements of any one of the lower molds in horizontal forward and backward directions among the four lower molds 30A, 30B, 30C and 30D.

Each of the driving means can be constituted by a drive cylinder driven by air pressure or hydraulic pressure and a linear motor. The dropping position and the molding position are respectively located at a horizontal rear side position and a horizontal right side position, with respect to the reference position. On the lower guide 50 of the total transporting unit, the four lower molds 30A, 30B, 30C and 30D are placed with equal intervals. Above the lower molds, corresponding four upper molds 40A, 40B, 40C and 40D are placed with equal intervals, and supported by the upper guide. The four pairs of molds 30A and 40A, 30B and 40B, 30C and 40C, 30D and 40D, are allowed to move as one group.

When the four pairs of molds, 30A and 40A, 30B and 40B, 30C and 40C, 30D and 40D, are aligned from left to right on the transporting path, the right end position of the paired molds 30A and 40A is defined as a reference position. This reference position forms a reference of reciprocal movements to and from the dropping position and a reference of movements toward the molding position. Moreover, this reference position may be used as a collecting position at which the molded product is collected.

The dropping position forms a position at which each of molten glass droplets 24 that drop in predetermined intervals is received successively by any one of the four lower molds 30A, 30B, 30C and 30D.

At the molding position, an upper mold is placed so as to be made face to face with the corresponding lower mold on which the molten glass droplet 24 has been put. The upper mold is driven upward and downward vertically by the press molding means. The press molding means may be formed by a drive cylinder that is driven by air pressure or hydraulic pressure. The molten glass droplet 24, placed on the lower molding surface of the lower mold, is pressed and molded between the lower molding surface of the lower mold and the upper molding surface of the upper mold.

In the manufacturing apparatus having the above-mentioned structure, the following description will discuss, for example, a process in which the dropping cycle of molten droplets 24 is set to four seconds while the molding cycle of the molten droplets 24 is set to 16 seconds.

First, the upper mold 40A of the paired molds 30A and 40A is located at the reference position, with the lower mold 30A being located at the dropping position, and the other paired molds, 30B and 40B, 30C and 40C, 30D and 40D, are positioned on the left side of the paired molds 30A and 40A. Molten glass droplets 24 are allowed to drop with an interval of 4 seconds, and upon detecting that the first molten glass droplet 24 has dropped onto the lower mold 30A, a molding cycle is started. Immediately after the start, the lower mold 30A is shifted to the reference position by the driving means. The lower mold 30A, returned to the reference position, is transported to the molding position together with the upper mold 40A (transportation on the first stage). At this time, the other paired molds, 30B and 40B, 30C and 40C, 30D and 40D, are also transported as one group, together with the paired molds 30A and 40A. As a result, the respective paired molds 30A and 40A, 30B and 40B, 30C and 40C, 30D and 40D, are moved to the next positions.

When the lower mold 30A has reached the molding position, the upper mold 40A is driven by the press molding means to move downward to press and mold the molten glass droplet 24 in cooperation with the lower mold 30A. The molded product is cooled with the molds being closed, and the paired molds 30A and 40A are successively sent to positions on the right side (transportation on the second stage, transportation on the third stage and transportation on the fourth stage). After a lapse of 14 seconds from the start of the molding cycle, the paired molds 30A and 40A are returned to the reference positions on the left side (transportation on the fifth stage), and the press molding means allows the upper mold 40A to move upward; thus, the molds are opened so that the molded product is taken out. After a lapse of 15 seconds from the start of the molding cycle, the driving means drives the lower mold 30A to move to the dropping position. After a lapse of 16 seconds from the start of the molding cycle, the lower mold 30A again receives the fifth molten glass droplet 24, and the above-mentioned operations are repeated.

On the other hand, in synchronism with the shifts of the paired molds 30A and 40A to the molding position, the paired molds 30B and 40B, located at a position that is one position before the reference position, are moved to the reference position by the driving means (transportation on the first stage). Thus, the lower mold 30B is moved to the dropping position by the driving means, with the upper mold 40B of the paired molds 30B and 40B being left at the reference position. Upon detection of the fact that the second molten glass droplet 24 has dropped on the lower mold 30B, the driving means immediately drives the lower mold 30B to move to the reference position. The lower mold 30B, returned to the reference position, is transported to the molding position together with the upper mold 40B (transportation on the second stage). At this time, the other paired molds, 30A and 40A, 30C and 40C, 30D and 40D, are also transported as one group, together with the paired molds 30B and 40B.

When the lower mold 30B has reached the molding position, the upper mold 40B is driven by the press molding means to move downward to press and mold the molten glass droplet 24 in cooperation with the lower mold 30B. The molded product is cooled with the molds being closed, and the paired molds 30B and 40B are successively sent to positions on the right side (transportation on the third stage and transportation on the fourth stage). The paired molds 30B and 40B are returned to a position that is one position before the reference position (transportation on the fifth stage). After a lapse of 18 seconds from the start of the molding cycle, the paired molds 30B and 40B are returned to the reference position (transportation on the first stage), and the press molding means allows the upper mold 40B to move upward so that the molded product is taken out. After a lapse of 19 seconds from the start of the molding cycle, the driving means drives the lower mold 30B to move to the dropping position. After a lapse of 20 seconds from the start of the molding cycle, the lower mold 30B again receives the sixth molten glass droplet 24, and the above-mentioned operations are repeated.

The other paired molds, 30C and 40C, 30D and 40D, are operated in the same manner as described above.

In the above-mentioned example, the four pairs of molds are successively used with a molding cycle of 16 seconds in association with a dropping cycle of 4 seconds so that all the molten glass droplets 24 are utilized without any loss of the molten glass droplets 24. In other words, by using the apparatus relating to the present invention, it becomes possible to further improve the utilization efficiency of the molten glass droplets 24 in comparison with the prior art apparatus.

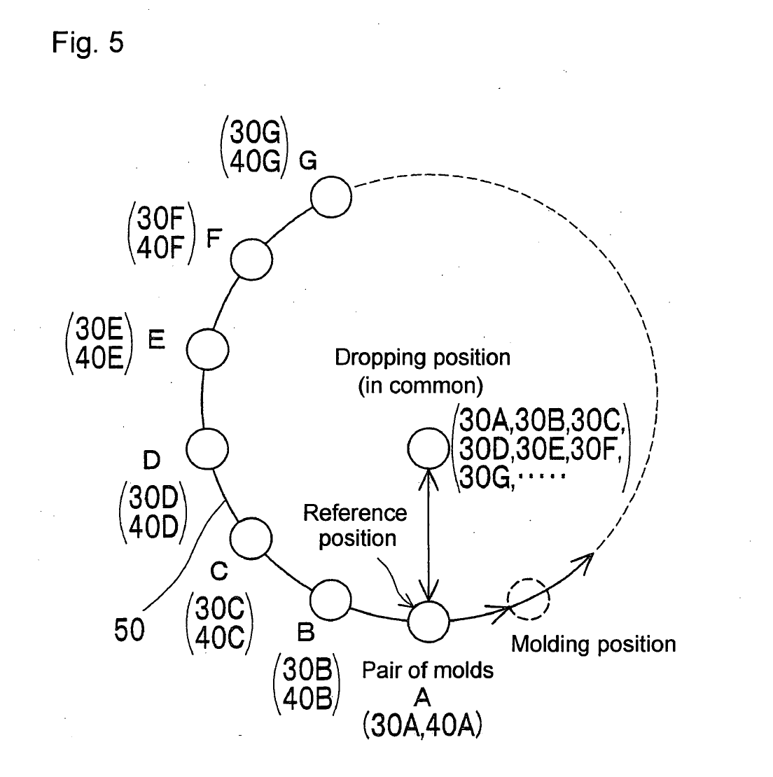

Referring to FIG. 5, the following description will discuss still another embodiment of the manufacturing apparatus of an optical element of the present invention in detail; however, by omitting overlapped explanations with the above-mentioned embodiment, points different from the above-mentioned embodiment are mainly explained.

FIG. 5 is an explanatory drawing that shows the manufacturing apparatus of an optical element of still another embodiment of the present invention viewed from above.

As shown in FIG. 5, the manufacturing apparatus is provided with: a molten glass supplying unit that supplies a molten glass droplet 24 to any one of seven lower molds 30A, 30B, 30C, 30D, 30E, 30F and 30G at the dropping position; a total shifting unit used for successively shifting seven pairs of molds, that is, 30A and 40A, 30B and 40B, 30C and 40C, 30D and 40D, 30E and 40E, 30F and 40F, 30G and 40G, as one group; a shifting unit that allows any one of the seven lower molds 30A, 30B, 30C, 30D, 30E, 30F and 30G to successively move between a dropping position and a reference position reciprocally in synchronized timing with the dropping of the molten glass droplet 24, and a press-molding unit that press-molds the molten glass droplet 24 at a molding position by using any one of the seven pairs of molds, that is, 30A and 40A, 30B and 40B, 30C and 40C, 30D and 40D, 30E and 40E, 30F and 40F and 30G and 40G.

The total transporting unit is constituted by a transporting path provided with a ring-shaped lower guide 50 that guides anticlockwise sliding movements of the seven lower molds 30A, 30B, 30C, 30D, 30E, 30F and 30G, and a ring-shaped upper guide that guides anticlockwise sliding movements of the seven upper molds 40A, 40B, 40C, 40D, 40E, 40F and 40G, a driving means that rotation-drives the seven pairs of molds 30A and 40A, 30B and 40B, 30C and 40C, 30D and 40D, 30E and 40E, 30F and 40F, 30G and 40G, anticlockwise as one group, and a controlling device that controls the timing of the anticlockwise rotation movements of the seven pairs of molds 30A and 40A, 30B and 40B, 30C and 40C, 30D and 40D, 30E and 40E, 30F and 40F, 30G and 40G.

The transporting unit is constituted by a lower guide that guides sliding movements in horizontal forward and backward directions of the seven lower molds 30A, 30B, 30C, 30D, 30E, 30F and 30G, a driving means that successively drives any one of the lower molds among the seven lower molds 30A, 30B, 30C, 30D, 30E, 30F and 30G reciprocally in horizontal forward and backward directions between the dropping position and the reference position, and a controlling device that controls the timing of the reciprocal movements in horizontal forward and backward directions between the dropping position and the reference position of any one of the lower molds among the seven lower molds 30A, 30B, 30C, 30D, 30E, 30F and 30G.

Each of the driving means can be constituted by a driving cylinder driven by air pressure or hydraulic pressure and a linear motor. The dropping position and the molding position are respectively located at a horizontal rear side position and a horizontal right side position, with respect to the reference position. On the lower guide 50 of the total transporting unit, the seven lower molds 30A, 30B, 30C, 30D, 30E, 30F and 30G are placed with equal intervals. Above the lower molds, the corresponding seven upper molds 40A, 40B, 40C, 40D, 40E, 40F and 40G are placed with equal intervals, and supported by the upper guide. The seven pairs of molds 30A and 40A, 30B and 40B, 30C and 40C, 30D and 40D, 30E and 40E, 30F and 40F, 30G and 40G, are allowed to move as one group.

When the seven pairs of molds, 30A and 40A, 30B and 40B, 30C and 40C, 30D and 40D, 30E and 40E, 30F and 40F, 30G and 40G, are aligned from left to right on the ring-shaped transporting path, the position of the pair of molds 30A and 40A, located at the right end position, is defined as a reference position. The reference position forms a reference of reciprocal movements to and from the dropping position and a reference of movements toward the molding position. Moreover, this reference position may be used as a collecting position at which the molded product is collected.

The dropping position forms a position at which each of molten glass droplets 24 that drop in predetermined intervals is received successively by any one of the seven lower molds 30A, 30B, 30C, 30D, 30E, 30F and 30G.

At the molding position, an upper mold is placed so as to be made face to face with the corresponding lower mold on which the molten glass droplet 24 has been put. The upper mold is driven upward and downward vertically by the press molding means. The press molding means may be formed by a drive cylinder that is driven by air pressure or hydraulic pressure. The molten glass droplet 24, placed on the lower molding surface of the lower mold, is pressed and molded between the lower molding surface of the lower mold and the upper molding surface of the upper mold.

In the manufacturing apparatus having the above-mentioned structure, the following description will discuss, for example, a process in which the dropping cycle of molten droplets 24 is set to two seconds while the molding cycle of the molten droplets 24 is set to 14 seconds.

First, the upper mold 40A of the paired molds 30A and 40A is located at the reference position, with the lower mold 30A being located at the dropping position. Moreover, the other paired molds, 30B and 40B, 30C and 40C, 30D and 40D, 30E and 40E, 30F and 40F, 30G and 40G, are positioned on the left side of the paired molds 30A and 40A. Molten glass droplets 24 are allowed to drop with an interval of 2 seconds, and upon detecting the first molten glass droplet 24 dropping onto the lower mold 30A, a molding cycle is started. Immediately after the start, the lower mold 30A is shifted to the reference position by the driving means. The lower mold 30A, returned to the reference position, is shifted to the molding position together with the upper mold 40A (transportation on the first stage). At this time, the other paired molds, 30B and 40B, 30C and 40C, 30D and 40D, 30E and 40E, 30F and 40F, 30G and 40G, are also transported as one group, together with the paired molds 30A and 40A. As a result, the respective paired molds 30A and 40A, 30B and 40B, 30C and 40C, 30D and 40D, 30E and 40E, 30F and 40F, 30G and 40G, are moved to the next positions.

When the lower mold 30A has reached the molding position, the upper mold 40A is driven by the press molding means to move downward to press and mold the molten glass droplet 24 in cooperation with the lower mold 30A. The molded product is cooled with the molds being closed, and the paired molds 30A and 40A are successively sent to positions on the right side (transportation on the second stage, transportation on the third stage, transportation on the fourth stage, transportation on the fifth stage and transportation on the sixth stage). After a lapse of 12.5 seconds from the start of the molding cycle, the paired molds 30A and 40A are returned to the reference position on the left side (transportation on the seventh stage), and the press molding means allows the upper mold 40A to move upward; thus, the molds are opened so that the molded product is taken out. After a lapse of 13 seconds from the start of the molding cycle, the driving means drives the lower mold 30A to move to the dropping position. After a lapse of 14 seconds from the start of the molding cycle, the lower mold 30A again receives the eighth molten glass droplet 24, and the above-mentioned operations are repeated.

On the other hand, in synchronous to the shifts of the paired molds 30A and 40A to the molding position, the paired molds 30B and 40B, located at a position that is one position before the reference position, are moved to the reference position by the driving means (transportation on the first stage). Thus, the lower mold 30B is moved to the dropping position by the driving means, with the upper mold 40B of the paired molds 30B and 40B being left at the reference position. Upon detection of the fact that the second molten glass droplet 24 has dropped on the lower mold 30B, the driving means immediately drives the lower mold 30B to move to the reference position. The lower mold 30B, returned to the reference position, is transported to the molding position together with the upper mold 40B (transportation on the second stage). At this time, the other paired molds, 30A and 40A, 30C and 40C, 30D and 40D, 30E and 40E, 30F and 40F, 30G and 40G, are also transported as one group, together with the paired molds 30B and 40B.

When the lower mold 30B has reached the molding position, the upper mold 40B is driven by the press molding means to move downward to press and mold the molten glass droplet 24 in cooperation with the lower mold 30B. The molded product is cooled with the molds being closed, and the paired molds 30B and 40B are successively sent anticlockwise (transportation on the third stage, transportation on the fourth stage, transportation on the fifth stage, transportation on the sixth stage and transportation on the seventh stage). After a lapse of 14.5 seconds from the start of the molding cycle, the paired molds 30B and 40B are returned to the reference position (transportation on the first stage), and the press molding means allows the upper mold 40B to move upward so that the molds are opened and the molded product is taken out. After a lapse of 15 seconds from the start of the molding cycle, the driving means drives the lower mold 30B to move to the dropping position. After a lapse of 16 seconds from the start of the molding cycle, the lower mold 30B again receives the ninth molten glass droplet 24, and the above-mentioned operations are repeated.

The other paired molds, 30C and 40C, 30D and 40D, 30E and 40E, 30F and 40F, 30G and 40G, are operated in the same manner as described above.

In the above-mentioned example, the seven pairs of molds are successively used with a molding cycle of 14 seconds in association with a dropping cycle of 2 seconds so that all the molten glass droplets 24 are utilized without any loss of the molten glass droplets 24. In other words, by using the apparatus relating to the present invention, it becomes possible to further improve the utilization efficiency of the molten glass droplets 24 in comparison with the prior art apparatus.

Here, a dropping cycle, a molding cycle, the number of paired molds to be used and a molding pattern, which are different from the above-mentioned embodiments, may be adopted. Moreover, a pair of upper and lower molds has been used so as to mold an optical element the upper and lower faces of which are molded faces; however, upon manufacturing a glass gob the lower face of which is a molded face with the upper face being a free face, only the lower mold may be used.

What is claimed is:

1. A manufacturing apparatus of a glass product, comprising:
a plurality of lower molds;
a nozzle for allowing a molten glass droplet to drop therefrom; and
a shifting unit for successively shifting any one of lower molds, selected among the lower molds, to a dropping position at which the molten glass droplet drops from the nozzle in synchronized timing with dropping of the molten glass droplet.

2. The manufacturing apparatus of claim 1, further comprising upper molds, in which after the lower mold has received the molten glass droplet, the lower mold is shifted to another molding position apart from the dropping position where the molten glass droplet is pressed and molded by the upper mold.

3. The manufacturing apparatus of claim 1, wherein a dropping cycle in which the molten glass droplets are allowed to drop is shorter than a molding cycle in which the molten glass droplet is molded by the upper mold and the lower mold.

4. The manufacturing apparatus of claim 1, wherein the glass droplet drops naturally by its self weight from the nozzle.

5. The manufacturing apparatus of claim 1, wherein the glass product is an optical element.

6. A manufacturing method of a glass product, comprising:
shifting one of plurality of lower molds to a predetermined dropping position;
dropping a molten glass droplet on the lower mold positioned at the dropping position from a nozzle;
moving the lower mold with the molten glass droplet received thereon from the dropping position; and
shifting another lower mold to the dropping position.

7. The manufacturing method of claim 6, further comprising:
press-molding the glass droplet on the lower mold moved from the dropping position in cooperation with an upper mold.

8. The manufacturing method of claim 6, wherein a dropping cycle in which the molten glass droplets are allowed to drop is shorter than a molding cycle in which the molten glass droplet is molded by the upper mold and the lower mold.

9. The manufacturing method of claim 6, wherein the glass droplet drops naturally by its self weight from the nozzle.

10. The manufacturing method of claim 6, wherein the glass product is an optical element.
